(19) United States
(12) Patent Application Publication
(10) Pub. No.: US 2007/0233743 A1
(43) Pub. Date: Oct. 4, 2007

(54) METHOD AND SYSTEM FOR SPATIAL AND ENVIRONMENTAL MEDIA-PLAYLISTS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/762,017

(22) Filed: Jun. 12, 2007

Related U.S. Application Data
(63) Continuation-in-part of application No. 11/267,079, filed on Nov. 3, 2005.
(63) Continuation-in-part of application No. 11/285,534, filed on Nov. 22, 2005.
(63) Continuation-in-part of application No. 11/383,195, filed on May 12, 2006.
(60) Provisional application No. 60/665,291, filed on Mar. 26, 2005.
(60) Provisional application No. 60/648,197, filed on Jan. 27, 2005.
(60) Provisional application No. 60/843,444, filed on Sep. 8, 2006.
(60) Provisional application No. 60/844,764, filed on Sep. 14, 2006.
(60) Provisional application No. 60/665,291, filed on Mar. 26, 2005.
(60) Provisional application No. 60/651,771, filed on Feb. 9, 2005.
(60) Provisional application No. 60/648,197, filed on Jan. 27, 2005.
(60) Provisional application No. 60/726,344, filed on Oct. 12, 2005.

(51) Int. Cl. G06F 17/30

(52) U.S. Cl. 707/104.1

(57) ABSTRACT

A system is disclosed for selecting musical media files from a plurality of available musical media files for play to a user based at least in part upon a current location of the user. In an embodiment, a spatial media server stores a set of geospatial playlists, each of which is associated with at least one designated location or area within the physical world. A processor implements a spatial media selection application configured to select a particular geospatial playlist from the set of geospatial playlists based on a current location of a portable electronic device of the user. In an embodiment, the spatial media selection application selects the particular geospatial playlist from the set of geospatial playlists based also on a current environmental condition proximal to the electronic device. An automated selection process is then used to select and play a particular media file from the selected geospatial playlist. The automated selection process may include a weighted random selection routine.

### RELATED APPLICATION DATA

This application is a continuation-in-part of U.S. patent application Ser. No. 11/267,079, entitled “System, Method, and Computer Program Product for Automatically Selecting, Suggesting, and Playing Music Media Files,” filed Nov. 3, 2005, which claims the benefit and priority under 35 U.S.C. § 119(e) of U.S. provisional patent application Ser. Nos. 60/665,291, filed Mar. 26, 2005 and 60/648,197, filed Jan. 27, 2005; this application also claims benefit and priority under 35 U.S.C. § 119(e) to U.S. provisional patent application Ser. No. 60/843,444, filed Sep. 8, 2006 and entitled “Method and System for Spatial and Environmental Playlists”; this application also claims benefit and priority under 35 U.S.C. § 119(e) to U.S. provisional patent application Ser. No. 60/844,764, filed Sep. 14, 2006 and entitled “Method and Apparatus for Intelligent media selection using Age and Gender”; this application is also a continuation-in-part of co-pending U.S. patent application Ser. No. 11/285,534, filed Nov. 22, 2005, which claims benefit and priority under 35 U.S.C. § 119(e) to U.S. provisional patent application Ser. Nos. 60/665,291, filed Mar. 26, 2005, 60/651,771, filed Feb. 9, 2005, and 60/648,197, filed Jan. 27, 2005; this application is also a continuation-in-part of co-pending U.S. patent application Ser. No. 11/383,195, filed May 12, 2006, which claims benefit and priority under 35 U.S.C. § 119(e) of U.S. provisional patent application Ser. No. 60/726,344, filed Oct. 12, 2005. This application is also related to U.S. patent application Ser. No. 11/223,368, filed Sep. 9, 2005 and entitled “System, method, and computer program product for collaboration and synchronization of media content on a plurality of media players,” which claims the benefit and priority under 35 U.S.C. § 119(e) of U.S. provisional patent application Ser. No. 60/644,417, filed Jan. 15, 2005. All of the patent applications identified above are to the instant inventor and a common assignee and are hereby incorporated by reference in their entirety as if fully set forth herein.

### FIELD OF THE APPLICATION

The present invention relates to locational configurable media playlist for a portable electronic device.

### BACKGROUND

Electronic Media Players have become popular personal entertainment devices due to their highly portable nature, their ability to provide accessibility to a large library of stored media files, and interconnectivity with existing computer networks such as, for example, the Internet. The accessibility and simplicity in downloading music and other electronic media continues to fuel the popularity of these devices as is exemplified by Apple Computer, Inc.'s highly successful iPod™ portable media player. Other manufacturers offer competing Media Players offering various functionalities and file playing compatibilities in an effort to differentiate their products in the marketplace.

As discussed in Apple Computer, Inc.'s patent application publication No. 2004/0224638, Ser. No. 10/423,490, the disclosure of which is herein incorporated by reference in its entirety, an increasing number of consumer products are incorporating circuitry to play musical media files and other electronic media. For example, many portable electronic devices such as cellular telephones and personal digital assistants (“PDAs”) include the ability to play electronic musical media in many of the most commonly available file formats such as Moving Picture Experts Group-1 (“MPEG-1”) Audio Layer 3 (“MP3”), Audio Video Interleave (“AVI”), Waveform audio format (“WAV”), Moving Picture Experts Group (“MPG”), Quicktime (“QT”), Windows™ Media Audio (“WMA”), Audio Interchange File Format (“AIFF”), Audio (“AU”), Real Audio Media (“RAM”), Real Audio (“RA”), Movie files (“MOV”), Musical Instrument Digital Interface (“MIDI”), and MIDI. With a wide variety of devices and file formats emerging, it is expected that in the near future a large segment of the population will have upon their person an electronic device with the ability access music files from a library of media files in local memory and/or over a computer network, and play those music files at will.

Often referred to as “playlists,” users of portable media players are generally enabled to create predefined electronic listings of musical media pieces that they desire to listen to in a certain order or within a certain time period. By defining such a playlist, a user may for example, define 20 songs that he or she wishes to listen to within the next hour. The media player will then access and play those songs to the user under the guidance of the predefined playlist. As used by the current art, playlists are generally temporally based and/or order based, meaning they define which songs should be played at certain times and/or which songs should be played in certain orders. Such a predefined playlist is highly convenient for users who wish to explicitly identify songs they are in the mood to listen to over an upcoming period of time. Such a predefined playlist does not, however, account for the fact that a user's mood for musical media may change rapidly as a user moves to different locations and/or is exposed to different environmental conditions. Such a predefined playlist that is temporally based and/or order based, also does not enable musical media files to be relationally associated with other factors such as spatial locations and/or environmental conditions.

### SUMMARY

Embodiments of the present invention are directed to methods, systems, and computer program products for enabling portable electronic devices to automatically select and play media based at least in part upon the current geospatial location of the portable device and a spatial playlist that is relationally associated to a location or area proximal to the current geospatial location. In some embodiments the spatial playlist includes a plurality of musical media files, all relationally associated to the same or similar location or area. In response to a user coming within certain physical proximity of that location or area, a musical media file is automatically selected from the plurality of musical media files and played to the user. In some embodiments it is automatically played. In other embodiments it is conditionally played based upon a required acceptance from the user. In this way a user who is traveling the real physical world with a portable media player and reaches a particular location, is provided with musical media files, either automatically or conditionally, that are selected from among a plurality of musical media files that are relationally associated with that location.

In some embodiments the media file selected from the spatial playlist by the routines of the present invention is played to the user immediately after a currently playing media file and/or currently scheduled media file completes play. In this way a user may reach a particular location or area while one media file is playing, the routines of the present selecting a next media file from the spatial playlist during this time. In this way a user may traverse the real physical world and be seamlessly played a sequence of musical media selections, one after another, each one selected based at least in part upon the current geospatial location of the user and a spatial playlist of musical media files that is associated with that location.

In some embodiments the spatial playlist may also include additional environmental parameters including lighting condition parameters, seasonal parameters, and weather condition parameters. Such parameters define the ambient environmental conditions that must also be met at a particular geospatial location or area for a spatial playlist to be employed when the user is located at that location. In this way spatial playlists may be expanded to spatial-environmental playlists wherein a one or more media items are associated with not just a location, but also a particular sunlight condition, season of year, and/or weather conditions. In this way a spatial playlist may define a set of songs that are appropriate for play at certain locations in the real physical world, provided that the environmental conditions at that location also include one or more of certain sunlight conditions, certain seasons, certain weather conditions. Thus, when a user of a portable electronic device comes within proximity of that location and during the corresponding environmental conditions, a song will be selected for play from that plurality of musical media content files. In some embodiments particular times-of-day or days-of-year are also included as conditional parameters, generally as ranges of values that correspond to particular seasons and/or lighting conditions present at particular geospatial locations or areas within the physical world.

In some embodiments additional motion parameters may be associated with a spatial playlist, including a direction of motion of the user, a facing direction of the user, a speed of motion of the user, and/or the duration for which the user has been within the particular location or area. In this way spatial playlists may be constructed such that a set of songs is not only associated with a particular location or area within the real physical world, but is also associated with how a user traverses that area, i.e., what direction the user is moving within the area, what direction the user is facing while within the area, what speed the user is moving when within the area, and/or how long the user has remained within the area. Such additional spatial parameters provide for highly customizable and flexible spatial playlists.

In some embodiments additional genre parameters may also be associated with a spatial playlist, defining a type, style, or taste parameter for the spatial playlist. In this way a plurality of spatial playlists may be associated with a particular location in the real physical world, each of the plurality of spatial playlists being associated with a different genre parameter. In this way a user may select a particular genre type for himself or herself when traversing the real physical world and may automatically access only those spatial playlists (or only those songs from within playlists) that are associated with both the locations that he or she is traversing and the genre type that he or she is selected. In this way a user may customize his or her spatial music experience to mesh with his personal taste and/or current mood in music.

Finally, in some embodiments a spatial playlist may also be associated with user access parameters, such parameters limiting access to the playlist only to certain people or members of certain groups or associations. In this way only certain users who enter a particular location or area within the real physical world will be provided a particular spatial playlist. In this way a group of friends may define spatial playlists and associate them with locations in the real physical world such that only members of that group of friends may access the spatial playlists when traversing the associated locations. Alternately, other groups such as teams, clubs, businesses, organizations, schools, and other defined organizations or social networks may be relationally associated with a given spatial playlist. In some embodiments a required password or authorization may further be associated with spatial playlist to limit access to those who possess such a password or authorization.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a generalized and exemplary block diagram of a portable media player according to an embodiment of the invention;

FIG. 2 illustrates a managed service using a spatial media server, which is connected or connectable to one or more networks according to an embodiment of the invention; and

FIG. 3 illustrates an exemplary flow diagram for the SMA routines of an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention address limitations of media players and conventional playlists by providing methods, apparatus, and computer program products that enable spatially associated and environmentally associated musical playlists.

A method, system, and computer program product is provided by the teachings discussed herein for enabling portable electronic devices to automatically select and play media based at least in part upon the current geospatial location of the portable device and a spatial playlist of musical media files that are relationally associated to a location or area proximal to the current geospatial location. In some embodiments the spatial playlist includes a plurality of musical media files, all relationally associated to the same or similar location or area. In response to a user coming within certain physical proximity of the location or area, a musical media file is selected from the plurality of musical media files, and played to the user. In some embodiments it is played to the user after a currently playing media file and/or currently scheduled media file completes play. In this way a user may traverse the real physical world and be played a sequence of musical media selections that are selected based at least in part upon the current geospatial location of the user and a spatial playlist of musical media files that is associated with a corresponding location or area. In some embodiments the spatial playlist may also include additional environmental parameters including lighting condition parameters, seasonal parameters, and weather condition parameters. In this way spatial playlists may be expanded to spatial/environmental playlists wherein a one or more media items are associated with not just a location, but that location at a particular time of day, season of year, and/or weather conditions. In this way a user may create listings of songs that are appropriate for play in certain locations, at certain times and/or during certain seasons and/or weather conditions, such that when a user of a portable electronic device comes within proximity of that location and during the corresponding environmental conditions, a song will be selected for play to that user from that plurality of musical media content files.

Electronic Media Players have become popular personal entertainment devices due to their highly portable nature, their ability to provide accessibility to a large library of stored media files, and interconnectivity with computer networks. Because emerging media player technologies are providing users with such large numbers of available music files from which to choose, the process of selecting a particular music file to play from the plurality of available music files can be challenging and time consuming for a user. To address such problems, methods, systems, and technologies have been developed by the current inventor as disclosed in co-pending U.S. patent application Ser. No. 11/267,079, filed on Nov. 3, 2005, co-pending U.S. provisional patent application Ser. Nos. 60/648,197, filed on Jan. 27, 2005, and 60/655,291, filed on Mar. 26, 2005, the disclosures of each of which are incorporated herein by reference. These references disclose a variety of methods by which software running upon a portable media player may intelligently suggest and/or select a music file based in part upon a user's current location and/or motion. These references also disclose a variety of methods by which software running upon a portable media player may suggest and/or select musical media files based in part upon the environmental conditions of the location of the user, including for example the weather conditions, seasonal conditions, and/or sunlight conditions of the location of the user. Such intelligent music selection methods account for the fact that a user's mood for music is likely to be affected by that user's location and/or by the current season, weather, and/or lighting conditions at that location. As an example, a user who is currently at a location corresponding to the beach, at night, in the summer, is likely to have his or her mood for specific musical media influenced by both the location and environmental conditions of the user. As discussed herein, computer programs, algorithms and routines are envisioned to be programmed in a high level language object oriented language such as, for example, Java™, C++, C#, or Visual Basic™.

More specifically, embodiments of the present invention enable the creation and usage of spatially associated playlists where one or more pieces of musical media may be relationally associated with a particular spatial location or area within the real physical world. In some preferred embodiments, a plurality of pieces of musical media are relationally associated with a particular location or area with the real physical world, where the plurality of pieces of media comprise a spatial playlist for that location or area. For example, a set of 100 pieces of musical media may be relationally associated with a particular location or area within the real physical world, that location or area corresponding for example to a particular stretch of beachfront property. A user of an enabled portable media player who goes to that particular stretch of beachfront property may access the playlist that has been relationally associated with that particular spatial area. While within the boundaries of that particular spatial area, software routines according to the present invention will automatically select pieces of media for play to the user from the set of pieces of music included in the spatial playlist. The selection process may be purely random, selecting 1 of the 100 pieces of music based upon a simple random selection algorithm. The selection process may be an intelligent weighted random selection process that uses additional factors such as a record of which songs a user has listened to recently and/or which songs a user is highly partial to, when selecting a song for play from among the set of songs included in the spatial playlist. In this way, the spatial playlist defines the set of songs from which a single song will be selected and played when the user is within the spatial area associated with the spatial playlist. Other routines are then used to select from within the set of songs, including purely random routines or intelligent routines. Methods for intelligent random selection are disclosed in the co-pending patent applications that have been incorporated herein by reference.

It should be noted that if the user remains within the spatial location or area associated with the spatial playlist after a first selected song completes playing, a next song will be selected and played from the set of songs included in the spatial playlist. In preferred embodiments the selection process uses elimination techniques such that the same song is not selected twice until all songs in the playlist have been played. In this way, a user can visit a particular location such as, for example, the beachfront property described previously, and have songs selected, one after another, from the set of songs included in the spatial playlist that is relationally associated with that particular area of beachfront property. In this way, the spatial playlist does not explicitly define what the user will listen to when at a location or area, but rather defines a set of songs that will be selected from among when the user is at that location or area. In a preferred embodiment the selection process is an intelligent random selection process that accounts for factors such as the user's listening history and the user's listening preferences. In certain embodiments, user characteristics such as the user's age and/or the user's gender are considered in the intelligent selection process. This enables a set of songs to be associated with a particular location that “fit the mood” of that location, but does not create a situation where a user always hears the same song when at that location. It also enables a selection process in which two different users who arrive at the same location at the same time and date, may be provided with different media from the same spatial playlist based on a randomized selection process and/or based on an intelligent selection process that is responsive to each user's unique listening preferences, listening history, age, and/or gender.

Embodiments of the present invention also enable a spatial playlist to further include environmental factors such as seasonal conditions, weather conditions, and lighting conditions. In this way certain pieces of musical media that are relationally associated with a particular location and/or area within the real physical world may be further relationally associated with certain environmental conditions and not with other environmental conditions. For example, a set of 20 songs of the 100 songs that were relationally associated with the beachfront property in the example above may be further relationally associated with WINTER seasonal conditions, while a different set of 30 songs of the 100 songs that were relationally associated with the beachfront property in the example above may be relationally associated with SUMMER seasonal conditions.

In this way, a user who physically resides at a particular location in the real physical world may access media from the listing of media incorporated with a playlist associated with that location and associated with one or more particular environmental conditions that match the current ambient environmental conditions of the user. Environmental conditions may include the current season (i.e., summer, winter, spring, or fall) at the time the user visits the location, the current weather conditions (e.g., sunny, rainy, snowy, overcast, stormy, or windy) at the time the user visits the location, the current lighting conditions (e.g., daylight, night time, twilight, sunrise, or sunset) at the time the user visits the location. Thus, a set of particular songs in the spatial playlist for the example stretch of beachfront property, may further be relationally associated with SUMMER and NIGHTIME. In this way a user who visits that location during the summer and during nighttime hours when the sun has gone down will be provided with a song from the set of songs relationally associated with that location and those environmental conditions.

It should be noted that time-of-day and day-of-year values may be used in combination with geospatial location values to correlate particular season and/or lighting conditions for a particular geospatial location. For example, a particular range of hours, on a particular day of the year, in a particular geospatial location, may deterministically correspond with NIGHTIME lighting conditions for that location.

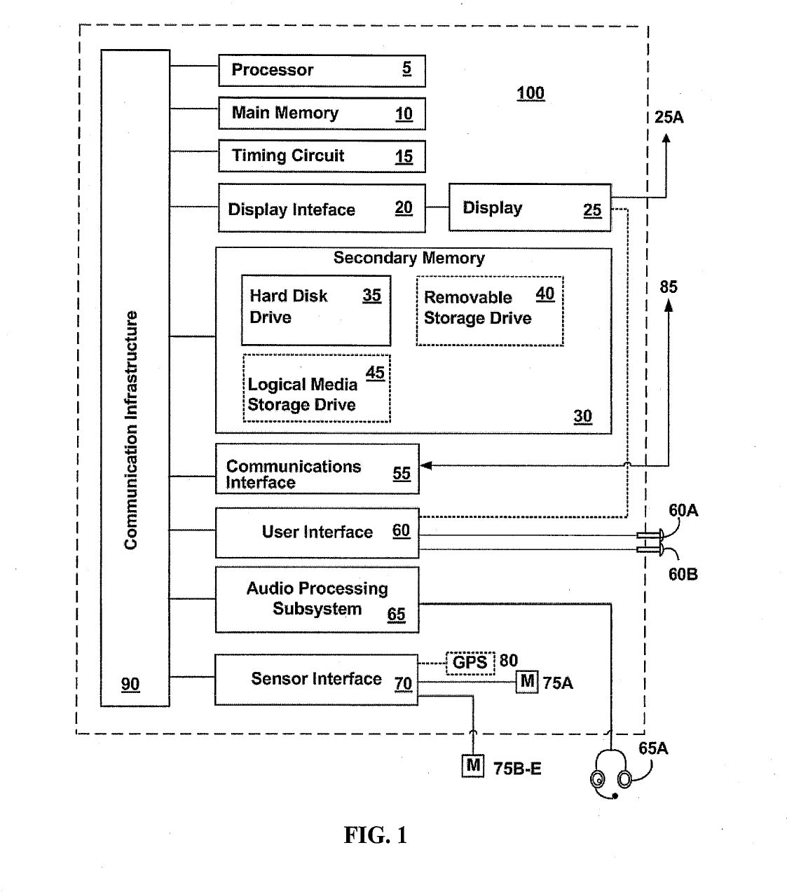

FIG. 1 illustrates a generalized and exemplary block diagram of a portable media player 100 according to an embodiment of the invention. The portable media player 100 includes a communications infrastructure 90 used to transfer data, memory addresses where data items are to be found and control signals among the various components and subsystems associated with or coupled to the portable media player 100. A processor 5 is provided to interpret and execute logical instructions stored in the main memory 10.

The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the portable media player 100 in near real time and may be used to make time-based assessments of sensor data collected by one or more internal sensors 75A, 80 and/or coupled to a sensor interface 70 which receives sensor data from one or more external sensors 75B-E.

Sensor 80 is a geospatial locative sensor that detects the current location of the portable media player as it is moved about the real world by its user. In many preferred embodiments sensor 80 is a Global Positioning System (“GPS”) 120 for use in tracking the location of portable media player in real time. GPS technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of the teachings discussed herein, the civilian service provided by Navstar™ GPS will be discussed with reference to embodiments of the invention. However, other positioning systems are also contemplated for use with the present invention, including newer versions of GPS that provide better accuracy and improved usage indoors.

In order for GPS to provide location identification information (e.g., a coordinate), the GPS system comprises several satellites, each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In some embodiments sensors 75A-E include at least one orientation sensor to gain orientation information about the user, where the orientation information reflects either the direction of motion of the user, the facing direction of the user, or the orientation of the portable media player with respect to the real physical world. In one embodiment, a magnetometer manufactured by Honeywell™ is included. Such an orientation sensor may be housed within the casing of the portable media player and is connected electronically to the microprocessor of the media player. Alternately, the orientation sensor may be worn by the user (e.g., on or within a belt or shoe or other article of clothing) such that it maintains a known orientation with respect to the user. Such an orientation sensor may be connected to the processor of the media player by a wired or wireless link. Orientation data may be used, in some embodiments, to relationally associate particular musical media files not just with a particular location of the user but also with a particular facing direction of the user (i.e., which way the user is looking when the song is selected).

Consistent with the some embodiments, at least a portion of the sensors 75A-E is configured to detect ambient environmental conditions within the user's local proximity. In alternate embodiments environmental conditions are accessed from tables and/or other data stores based upon current time and/or date information from timing circuit 15. For example, current seasonal conditions and/or sunlight conditions may be determined from a data store by referencing current time and/or date information from the timing circuit. The processor 5, main memory 10 and timing circuit 15 are directly coupled to the communications infrastructure 90. In some embodiments ambient environmental conditions, such as weather conditions, are accessed from a remote server over a network connection based upon the current geospatial location of the user. For example, the portable media player 100 may report a current location to a remote server such as a weather server and receive in response current ambient weather condition data for the current location of the user. Thus, either by direct sensing or by accessing stores of information, current ambient environmental condition information may be determined and/or accessed by the routines of the present invention.

A display interface 20 is provided to drive one or more displays 25, 25A associated with the portable media player 100. The display interface 20 is electrically coupled to the communications infrastructure 90 and provides signals to the display(s) 25, 25A for visually outputting both graphics and alphanumeric characters. In an exemplary embodiment, a display 25 may be incorporated into the housing of the portable media player 100 and/or may be another separate device worn by the user 25A.

The display 25 may also be coupled to a user interface 60, 60A,B for interacting with software being executed by the processor 5. The display interface 20 may include a dedicated graphics processor and memory to support the displaying of graphics intensive media. The internal display 25 may be of any type (e.g., cathode ray tube or gas plasma) but in most circumstances will usually be a solid state device such as liquid crystal display. The external display 25A necessitates a lightweight construction, generally an LCD screen.

A secondary memory subsystem 30 is provided which houses retrievable data storage units such as a hard disk drive 35, an optional removable storage drive 40, and/or an optional logical media storage drive 45. One skilled in the art will appreciate that the hard drive 35 may be replaced with flash memory. The secondary memory 30 may be used to store a plurality of media files, including but not limited to a plurality of digital songs, a plurality of digital images, a plurality of personal photographs, a plurality of video files, and/or a plurality of other media items.

The optional removable storage drive 40 may be a replaceable hard drive, optical media storage drive or a solid state flash RAM device. Both the optional removable storage drive 40 and optional logical media storage drive 40 may include a flash RAM device, an EEPROM encoded with playable media, or optical storage media (e.g., CD or DVD). The optional removal storage drive 40 may be connected directly to the communications infrastructure 90 or in alternate exemplary embodiments, via a communications interface 55.

The communications interface 55 subsystem is provided which allows for electrical connection of peripheral devices to the communications infrastructure 90 including serial, parallel, USB, or Firewire™ connectivity and proprietary communications connections usually associated with a docking cradle (not shown).

The communications interface 55 also facilitates the remote exchange of data and synchronizing signals between the portable media player 100 and other devices in processing communications 85 with the portable media player 100. The other devices may include one or more external sensors 75B-E that are disposed elsewhere upon the user's body. The other devices may also include a wireless headset 65A, a remote display 25A, another portable media player and/or a remote server. The remote server may be a spatially associated server that stores spatial playlists and access them based upon locative data received from the portable media player 100 over the communication link. For example, the portable media player may report its current location to such a remote server and in response receive a spatial playlist for that location or area. Alternatively, the remote server may maintain the spatial playlist and may perform the selection process, returning the selection to the portable media player 100 based upon the locative information received from the media player over the communication link.

The communications interface 55 is envisioned to include a radio frequency transceiver normally associated with wireless computer networks for example, wireless computer networks based on BlueTooth™ or the various IEEE standards 802.11x, where “x” denotes the various present and evolving wireless computing standards such as, for example, WiMax 802.16 and WRANG 802.22. Alternatively, digital cellular communications formats compatible with for example GSM, 3G and evolving cellular communications standards. Both peer-to-peer (“PPP”) and client-server models are envisioned for implementation of the invention. In a third alternative exemplary embodiment, the communications interface 55 may also include hybrids of computer communications standards, cellular standards and evolving satellite radio standards.

A user interface 60 is provided as the means for a user to control and interact with the portable media player 100. The user interface 60 provides interrupt signals to the processor 5 that may be used to interpret user interactions with the portable media player 100. For purposes of the teachings discussed herein, the term “user interface” 60, 60A,B includes the hardware and operating software by which a user interacts with the portable media player 100 and the means by which the portable media player 100 conveys information to the user. The user interface 60 may be used in conjunction with the display(s) 25, 25A in order to simplify interactions with the portable media player 100 when the user is performing physical activities. The user interface 60 employed on the portable media player 100 may include a pointing device (not shown) such as a mouse, thumbwheel or track ball, an optional touch screen (not shown); one or more push-button switches 60A, 60B; one or more sliding or circular potentiometer controls (not shown) and one or more switches (not shown.)

An audio processing subsystem 65 is provided to output analog audio to the user's headset 65A and input commands, messages and other verbal information from a microphone attached to the headset 65A. The audio processing subsystem 65A is generally known in the relevant art, for example, personal computer sound cards.

When the sensors 75B-E are external to the portable media player 100, a preferred wireless 85 arrangement may be provided which utilizes for example, Bluetooth™ or an equivalent wireless technology. Where required, the sensors 75A-E, 80 may be connected through a separate sensor interface 70. In such circumstances, the sensors 75A-E, 80 may be directly connected to the sensor interface 70 or indirectly utilizing the communications interface 55 and the communications infrastructure 90 to transfer information to the sensor interface 70.

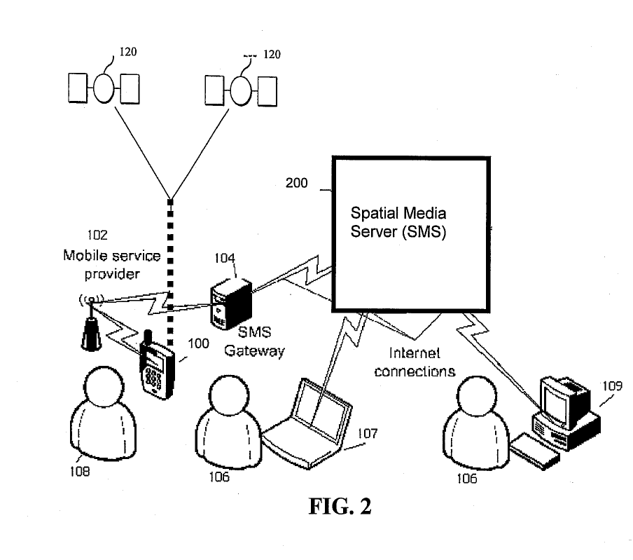

FIG. 2 illustrates a managed service (e.g., in an ASP model) using a spatial media server (“SMS”) 200, which is connected or connectable to one or more networks according to an embodiment of the invention. For illustrated purposes, the SMS server 200 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described below. In a typical implementation, the service comprises a set of one or more computers. A representative machine is a network-based server running commodity (e.g., Pentium-class) hardware, an operating system (e.g., Linux, Windows, or OS-X), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment. As illustrated FIG. 1, the SMS server 200 may be in communication with a mobile service provider (MSP) 102 through a gateway, such as sms gateway 104.

As also illustrated in FIG. 2, one or more users 106 register for the service, typically by using a client machine which may be the portable media player 100 or some other machines such as a laptop 107 or desktop computer 109. When a desktop computer is used, registration is initiated by an end user opening a Web browser to the operator's Web site registration page (or set of registration pages). When a portable media player is used, registration may be initiating through a mini-browser or other similar interface. These techniques are merely representative, as any convenient technique (including, without limitation, email, filling out and mailing forms, and the like) may be used. Thus, in the illustrated embodiment, users register with the SMS server 200 (or set of servers) either through Internet connections from personal computers, or via remote registration through a mobile device.

Also illustrated in FIG. 2 is a Global Positioning System (GPS) 120 for use in tracking the location of portable media player devices such as portable media player 100 as moved about by a user in the real physical world. Thus portable media player may determine its current location within the real physical world and using a GPS sensor local to the media player. Based upon the locative information from the GPS sensor, a spatial playlist is accessed that is relationally associated to the location or area of the user as reported by the GPS sensor. The spatial playlist may be accessed from local memory on board the portable media player. The spatial playlist may be accessed from server 200 over a wireless communication link. Because a vast number of different spatial playlists may be composed by a variety of people, each playlist specially customized for a vast number of different physical locations within the real physical world, server 200 may exist as the repository for spatial playlists. In this way a user of a portable media player 100 may travel to any of a large number of locations or areas within the real physical world and access from server 200 a spatial playlist that has been specially composed for that particular location or area. For embodiments that support environmental conditions as well, the server 200 may include a plurality of playlists for each spatial location, each of said plurality of playlists corresponding to a different environmental condition that could be present at the given location. In this way, a portable media player 100 may report both a current position and a current set of environmental conditions to server 200 and in return may be provided with a spatial/environmental playlist that corresponds to the unique location and unique environmental conditions of the user at the present time. The playlist may be communicated as a set of songs that are relationally associated with the current location and environmental conditions. In an alternate embodiment the playlist is accessed on the remote server but not communicated to the media player. Instead the server makes a selection from the playlist and sends only the selection indication to portable media player 100.

Embodiments of the present invention generally include at least one Spatial Music Application that uses, at least in part, the current geospatial location of the portable media player and at least one spatial playlist that associates musical media pieces with a corresponding location and area, to select a musical media piece for play to the user. The Spatial Musical Application, or “SMA” as referred to herein, may be configured to automatically select a song for play to a user from the spatial playlist or may be configured to suggest the song and enable the user to conditionally accept or reject its play. The SMA application may reside upon the portable media player of the user, may reside upon an external SMS server 200 that is accessed by the portable media player, or may be distributed such that it resides partially upon both the portable media player and a spatial media server.

The Spatial Music Application, either running wholly upon the portable media player or in combination with routines running upon the SMS server 200 is configured to enable portable electronic devices to automatically select and play media based at least in part upon the current geospatial location of the portable device and a spatial playlist of musical media files though which said media files are relationally associated to a location or area proximal to the said current geospatial location. In a preferred embodiment a large plurality of spatial playlists is stored upon the SMS server 200, each of said large plurality of spatial playlists being associated with different locations and/or areas within the real physical world. In this way vast numbers of locations within the real physical world may be associated with listings of musical media pieces that are particularly appropriate for such locations. In some embodiments the songs are all listed as being evenly appropriate for the locations or areas they are relationally associated with. In other embodiments the songs may be associated with priority parameters or other indicators that indicate certain songs as being more appropriate for the particular location or area than other of such songs.

In general a large store of spatial playlists, each associated with different locations or areas within the real world, is referred to as a Spatial Playlist Database. This database may locally reside upon the portable media player or may reside upon the Spatial Media Server. A substantial benefit of having the Spatial Playlist Database residing upon the Spatial Media Server is that it may be a shared resource among a large number of users, the shared resource being collaboratively created, updated, and used by the large number of users who access the database remotely. Thus, referring back to FIG. 2, the architecture according to the present invention may be constructed such that a Spatial Music Application runs upon a portable media player 100, the media player accessing an SMS server 200, which runs related routines and houses or accesses a Spatial Playlist Database. The spatial playlist database includes a plurality of spatial playlists, each associated with different locations or areas within the real physical world. In addition, each spatial playlist may be relationally associated with environmental parameters, motion parameters, genre parameters, and user access parameters. These additional parameters will be described in more detail later in this document. A particular spatial playlist is accessed from among the plurality of spatial playlists based at least in part upon current geospatial location data for the portable media player as accessed with reference to a locative sensor such as a GPS sensor that accesses satellites 120.

With respect to each spatial playlist itself, in the most common embodiments each spatial playlist includes a plurality of musical media files, all relationally associated to the same or similar location or area. In response to a user coming within certain physical proximity of that location or area, a musical media file is automatically selected from the plurality of musical media files and played to the user. In some embodiments it is automatically played by the SMA routines. In other embodiments it is conditionally played by the SMA routines based upon a required acceptance from the user. In this way a user who is traveling the real physical with a portable media player and reaches a particular location, is provided with musical media files, either automatically or conditionally, which are selected by the SMA routines from among a plurality of musical media files that are relationally associated with that location.

In some embodiments the media file selected by the SMA routines from an appropriate spatial playlist is played to the user immediately after a currently playing media file and/or currently scheduled media file completes play. In this way a user may reach a particular location or area with the real physical world while one media file is playing, the routines of the present selecting a next media file from the spatial playlist during this time and playing it upon the completion of the currently playing media file. In this way a user may traverse the real physical world and be seamlessly played a sequence of musical media selections, one after another, each one selected based at least in part upon the current geospatial location of the user and a spatial playlist of musical media files that is associated with that location. In a common embodiment, musical media files are repeatedly selected from a first spatial playlist, one after another, while a user is at a location that corresponds with the first spatial playlist. Once a user moves to a new location that no longer corresponds with the first spatial playlist, but does correspond to a second spatial playlist, media files are repeatedly selected from the second spatial playlist. This process may repeat with third, forth, etc. . . . spatial playlists as a user traverses the real physical world. In this way a user may wander the real physical world at his own pace and discretion and be repeatedly provided with musical media files that are selected, at least in part, based upon the physical location of the user.

In some embodiments priority parameters may be associated with particular songs within a particular spatial playlist, priority parameters being used to increase the chances that certain songs within the list are selected and played than other songs within the playlist. In this way certain songs may be indicated as having higher priority for play when a user enters the associated location or area than other songs. This allows for further control over the musical experience a user may have when traversing certain locations and/or areas. This is particularly useful for SMA routines that employ a weighted random selection process for selecting a media item from among the plurality of media items listed in a playlist. In such routines songs with higher priority parameters will be assigned a higher statistical chance of being selected using the weighted random selection routines than other songs of lower priority parameters. Details upon the operation of weighted random selection routines are disclosed in co-pending patent applications that have been incorporated herein by reference.

In some embodiments spatial playlist may include environmental parameters, including lighting condition parameters, seasonal parameters, and weather condition parameters. Such parameters define the ambient environmental conditions that must also be met at a particular geospatial location or area for a spatial playlist to be employed when the user is located at that location. In this way spatial playlists may be defined such that the set of one or more media items it includes are associated with not just a location or area, but also particular sunlight conditions, seasons of the year, and/or weather conditions at that particular location or area. For example, a playlist may be defined such that it is relationally associated with a particular stretch of beachfront property (i.e., an area) and may be further relationally associated with the seasons of Spring and Summer (i.e., seasonal conditions). It may also be further relationally associated with the sunlight conditions of, for example, daylight. In this way, a user who travels to that particular location during those particular seasons, during times when it is daylight at that location, will be enabled to access the particular spatial playlist and thus will be played one or more songs it contains. This is particular beneficial, presuming the playlist is defined to include songs that are particularly well suited to that location, during those seasons, and during daylight hours. A separate playlist may be defined for the same location, the same seasons, and nighttime hours. The songs included would ideally be more appropriate for the nighttime environment of that location during those seasons. In this way, the spatial world may be relationally associated with songs that are well matched to particular locations and particular environmental conditions. Typical Seasonal Parameters include Winter, Spring, Summer, and Fall. Typical Sunlight Parameters include (daytime, nighttime, twilight, sunrise, and sunset). Typical Weather Parameters include (sunny, rainy, snowy, hot, cold, windy, stormy, balmy, and overcast). In some embodiments particular times-of-day or days-of-year are also included as conditional parameters. In this way a spatial playlist may define a set of songs that are appropriate for play at certain locations in the real physical world, at certain times of day or days of the year. Because sunlight conditions and seasonal conditions may be derived deterministically from location data, time of day data, and day of year data, these values may be used in combination to establish the seasonal and/or sunlight values described previously.

The environmental conditions associated with playlists are used in combination with actual environmental conditions present in the local proximity of the user when the user traverses the real physical world. These actual conditions may be derived from local sensor on the user or may be derived from a remote server based upon location values for the user as well as current time and date values. In such situations, a store of data is generally also included that relates particular locations, times of day, and days of year, to certain sunlight conditions and/or seasonal conditions. For example, a sunrise/sunset table may be employed for various locations within the real physical world. In some embodiments such a table is accessed remotely over a communication network, so as to determine the current sun conditions and/or seasonal conditions for the current location and current time and current date of the portable media player.

With respect to current weather conditions in the ambient local proximity of the user as he or she traverse the real physical world, these values may be accessed from a remote server over a network connection based upon the current geospatial location of the user. For example, the portable computing device 100 may report a current location to a remote server such as a weather server and receive in response data indicating the current ambient weather condition data for the current location of the user. This data is then used when accessing the Spatial Playlist Database, spatial playlist being selected being one that corresponds to or includes the current ambient weather condition as a parameter. In this way, current ambient environmental condition information for the proximal surroundings of the user may be used by the routines according to the present invention when accessing and using a spatial playlist.

In some embodiments additional motion parameters may be associated with a spatial playlist, including a direction of motion of the user, a facing direction of the user, a speed of motion of the user, and/or the duration for which the user has been within the particular location or area. In this way spatial playlists may be constructed such that a set of songs is not only associated with a particular location or area within the real physical world, but is also associated with how a user traverses that area, i.e., what direction the user is moving within the area, what direction the user is facing while within the area, what speed the user is moving when within the area, and/or how long the user has remained within the area. Such additional spatial parameters provide for highly customizable and flexible spatial playlists.

Such parameters are used in combination with actual motion values for the user as he or she traverses the real physical world. These actual motion values may be derived from the GPS sensor 80 local to the portable media player 100 and/or from a separate orientation sensor such as a magnetometer that detects the facing direction of the user. In addition, the timing circuit 15 may be used to determine an accrued duration during which the user (or media player) is within a certain location or area or has moved a certain distance (to determine velocity). Thus the routines of the present invention may have access to the user's actual motion characteristics including the user's direction or motion, facing direction, speed of motion, and/or duration for which the user is within a particular location or area. Having such actual motion characteristics of the user as well as having spatial playlists that are associated with certain required motion characteristics, the routines according to the present invention may be configured to select a playlist based at least in part upon the matching between a required motion parameter and an actual motion characteristic of the user. In one example, Spatial Playlists may be associated with particular facing directions of the user. For example, a spatial playlist associated with a certain stretch of beachfront property may also be related to a range of facing directions that are substantially in the direction of the ocean. A separate playlist may be associated with the same stretch of beachfront property but may be related to a range of facing directions that are substantially in the direction of the surrounding hills. In this way, a spatial playlist for a given location or area may be further specific to a particular direction the user is facing. Facing direction data, as described previously, may be derived from magnetometer data from a worn sensor on the user's belt or shoes, for example.

In another example, spatial playlists may be associated with a particular speed or range of speeds of motion of the user. For example, a spatial playlist may be a spatial playlist associated with a certain stretch of beachfront property may also be related to a range speeds that generally relate to walking. A separate playlist may be associated with the same stretch of beachfront property but may be related to a range of speeds that generally relate to driving. In this way a spatial playlist for a given location or area may be further specific to a particular range of speeds of travel of the user.

In some embodiments additional genre parameter may also be associated with a spatial playlist, defining musical type, musical style, or musical taste parameters for the spatial playlist. In this way a plurality of spatial playlists may be associated with a particular location in the real physical world, each of said plurality of spatial playlists being associated with a different genre parameter. In this way a user may select a particular GENRE TYPE for himself or herself when traversing the real physical world and the SMA routines according to the present invention automatically access only those spatial playlists that are associated with both the locations that he or she is traversing and the genre type that he or she is selected. For example, if the user selects Country Music as his current genre type by selecting it from a menu on his portable media player, that user would be provided with a variety of spatial playlist when, going form location to location in the real world, the playlists being selected only from among only those playlists associated with Country Music as its genre parameter. Conversely, if a different user selects Classic Rock as his current genre type from a menu on his portable media player, that user would be provided with a different variety of spatial playlist when going form location to location in the real world, the playlists being selected only from among only those playlists associated with Classic Rock as its genre parameter. In this way users with different musical tastes or moods may configure their portable media player such that the SMA routines only select from among spatial playlists and/or only select songs from within spatial playlists that are associated with particular defined genre parameters.

In some embodiments a spatial playlist may also be associated with user access parameters, such parameters limiting access to the playlist only to certain people or members of certain groups or associations. In this way, only certain users who go to a particular location or area within the real physical world will be provided a particular spatial playlist. In this way a group of friends may define spatial playlists and associate them with locations in the real physical world such that only members of that group of friends may access the spatial playlists when traversing the associated locations. Alternatively, other groups such as teams, clubs, businesses, organizations, schools, and other defined organizations or social networks may be relationally associated with a given spatial playlist. In some embodiments, a required user ID or group ID is required within the portable media player of a user for that user to gain access to a spatial playlist with user access parameters. In some embodiments a required password or authorization may further be associated with spatial playlist to limit access to those who possess such a password or authorization. As an example, a particular spatial playlist may be defined for a group of users who go to a particular school. This playlist is tagged with a user access parameter User Access Parameter=Spalding High School. In this way only members who configured personal parameters within their portable media player and/or configure a personal parameter page on a related external server such that they are identified as a member of the Spalding High School group, will have access to the particular spatial playlists tagged with the aforementioned spatial access parameter.

It should be noted that a single spatial playlist may be relationally associated with a plurality of separate locations and/or areas within the real physical world. For example, a spatial playlist may be relationally associated with three separate beaches in three separate parts of California because the songs are appropriate for all three. In addition a single spatial playlist may be relationally associated with a plurality of separate groups of users, a plurality of separate environmental conditions, and/or a plurality of separate motion parameters. In this way a single playlist may have a variety of locations and/or conditions for which it is appropriate.

In addition there may be situations where multiple spatial playlists overlap in geospatial space such that a plurality of playlists may be identified as being appropriate for a particular media player user at a particular location in the real physical world. In some embodiments such situations are handled by the SMA routines such that one of the plurality of playlists may be selected based upon a random selection or weighted random selection method. Once a playlist is selected, a song is then selected from the playlist using a random selection or weighted random selection method. In other embodiments the situation of multiple playlists is handed differently, with a song being selected at random (either direct random or weighted random) from the set of songs that is the union of the sets defined by the multiple playlists. In some such embodiments those songs that are present on both playlists, i.e. the set of intersecting songs, may be given higher priority in the selection process than those songs that are not present on multiple playlists.

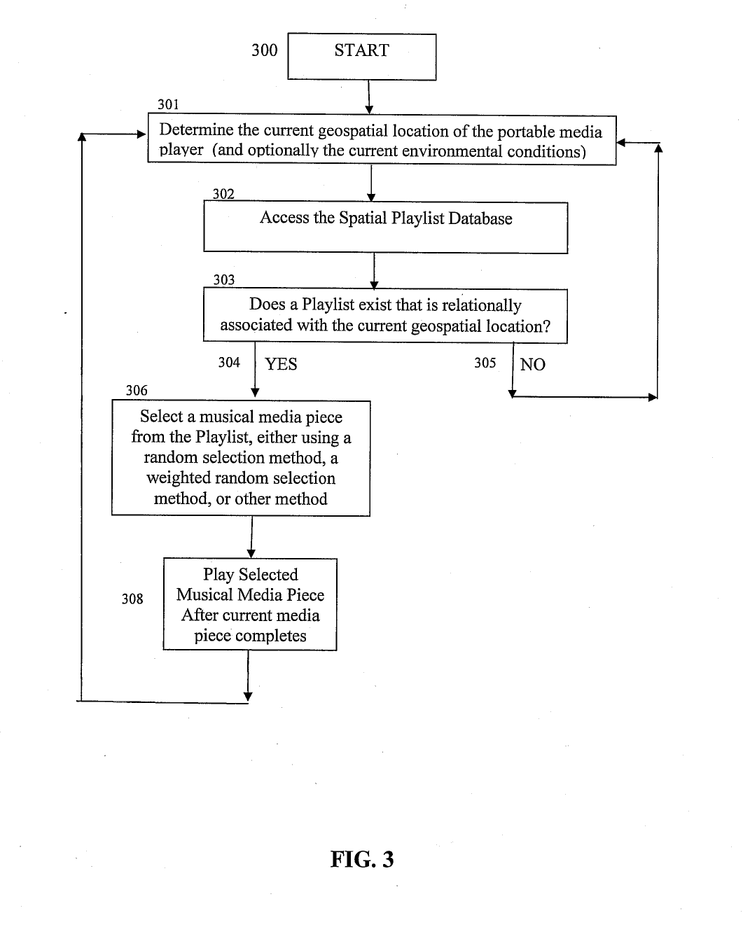

FIG. 3 illustrates an exemplary flow diagram for the SMA routines of an embodiment of the invention. These routines generally are run in parallel with other program functions such as, for example, functions that access and play media files, control time and date, and enable person to person communication or web browsing. These routines may be structured to run on a single processor or multiple processors. The flow shown in FIG. 3 is a simplified flow that isolates only certain key steps in the operation. The process begins at step 300 when the program is called by a function call or other programming construct. This call may be performed in response to a previous media file nearing completion of play, thus it is called in anticipation of a next media file needing selection. It may be called by another routine that selects media files at random or based upon some other heuristic, unless there is a media file dictated by a spatial playlist available for the current location of the user that would take precedence. Thus, prior to start 300, the media player may have been automatically selecting and playing media files to the user based upon an alternate sequential, random, weighted random, or otherwise intelligent or non-intelligent media selection process. The software proceeds to step 300 to check whether any spatially related media playlists are available that relate to the user's current location.

The process begins at 301 where the routines determine or otherwise access the current geospatial location of the portable media player. This may be performed by accessing data from GPS sensor 80. In some embodiments additional orientation sensors may be accessed such as a magnetometer that determines the user's facing direction. In some embodiments additional current locative parameters may be determined for the user including his or her direction of travel and/or speed of travel. In some embodiments, current environmental conditions are also determined based upon the current location (and optionally the current time and/or date). These current environmental conditions may include current weather conditions for the ambient proximity of the user, the current sunlight conditions for the ambient proximity of the user, and/or the current season for the ambient proximity of the user.

The process then proceeds to step 302 wherein a Spatial Playlist Database is accessed. This database may be stored locally within the portable media player 100 or may be accessed at a remote server 200 over a communication link. At a minimum the database is accessed with index values describing the current geospatial location of the user. In some embodiments the database is indexed with respect to additional current locative factors for the user such as the current facing direction of the user, or the current motion direction or speed of the user. In some embodiments the database is indexed with respect to additional current environmental factors for the environment of the user, including the current time, date, weather conditions, seasonal conditions, and/or lighting conditions. In this way a spatial playlist may be identified that best matches the current location and related environmental conditions of the user.

In step 303 a playlist is identified which best matches the current location and optionally other environmental factors of the user. A conditional assessment is also made as to whether or not a spatial playlist exists in the database that matches the current location (and optionally other conditions) of the user at a sufficient level. If not, the process proceeds to 305 where it loops back to 301 and repeats based upon updated locations of the user. In some embodiments it only repeats at step 301 after the user has changed his or her current location by more than some minimal threshold distance. In other embodiments the process does not repeat but instead returns control to whatever process had called step 300 and thereby repeats based upon the control of that calling routine.

If, at step 303, it is determined that a spatial playlist does exist that is relationally associated with the current geospatial location of the user (and optionally meets other factors), the process proceeds along 305 to step 306. At step 306 a selection routine is used to select a media file from the spatial playlist. This playlist may include many listed musical media pieces, for example 100 listed media titles. Thus a variety of different routines may be used to select one of the plurality of media items listed within the playlist. As described previously this may be random selection process, a weighted random selection process, a prioritized random selection process, or some other selection process. In some embodiments the selection process is configured to consider how recently the user has listened to various songs in the playlist, providing higher priority to songs that have not been listened to in a longer period than songs that have been listened to recently. In some such embodiments songs that have been listened to very recently are eliminated from consideration in the selection process. In some embodiments user taste factors are also considered in the selection process, reducing the priority or eliminating songs from possible selection that the user may not have personal taste preferences for. In some embodiments it is an elimination selection process is also employed such that a media file may only be selected once until all media files referenced by the playlist are selected. Exemplary selection processes are disclosed in the co-pending patent applications that have been incorporated herein by reference. Regardless of what selection process is used, a media file is identified for play from the playlist in step 306. The program flow then proceeds to step 308.

At step 308 the identified media file is played. In the most common embodiment this occurs after a currently playing media file completes play. In some embodiments it is after all currently scheduled media files complete play. In some embodiments in which the media file does not play immediately, it may only subsequently begin play if the user remains within the associated spatial area at the time when play would begin. Once the media file begins play, or is scheduled for play, the process loops back to 301 and repeats based upon updated locations of the user. In other embodiments the process does not repeat but instead returns control to whatever process had previously called step 300 and thereby repeats based upon the control of that calling routine. It should be noted that in some embodiments the selected musical media piece is presented to the user as a suggestion and the user employs the user interface functions of media player 100 to accept or reject the spatially related musical media selection.

With respect to the structure of spatial playlists themselves, they may take the form of a variety of data structures. In some embodiments they are listing of the titles or other identifiers that indicate unique musical media pieces included. In some such embodiments the listings are of unique ID numbers or codes associated with each unique musical media piece included in the spatial playlist. In some embodiments the playlist includes pointers to the actual media files themselves that represent the content of the musical media pieces. In this way the spatial playlist may include a set of values that define a geospatial location or area to which the playlist is relationally associated, a listing of unique musical media pieces by numeric, textual, or coded identifier, and optional other parameters such as motion parameters, weather parameters, sunlight parameters, user access parameters, other environmental condition parameters, and/or date and time parameters. The parameters may be single values or ranges of values.

The various exemplary embodiments described herein are merely illustrative of the principles underlying the inventive concept. It is therefore contemplated that various modifications of the disclosed exemplary embodiments will, without departing from the spirit and scope of the various exemplary invention embodiments will be apparent to persons of ordinary skill in the art. In particular, it is contemplated that functional implementation of the various exemplary embodiments described herein may be implemented equivalently in hardware, software, firmware, and/or other available functional components or building blocks.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A system for selecting and playing musical media in response to a user's geospatial location, the system comprising:
a portable electronic device adapted play musical media files to a user;
a spatial media database including a set of geospatial playlists, each geospatial playlist comprising a listing of a plurality of musical media files, each geospatial playlist being relationally associated with at least one geospatial location or geospatial area;
one or more processors to implement a spatial music application, the spatial music application configured to:
select a geospatial playlist from the set of geospatial playlists based at least in part upon a correlation between a determined current geospatial location of the portable electronic device and the at least one geospatial location or geospatial area associated with the selected geospatial playlist;
identify for play, using an automated media file selection process, a particular musical media file from the plurality of musical media files listed in the selected geospatial playlist; and
cause to play on the portable electronic device, at least a portion of the identified particular musical media file.

2. The system of claim 1 wherein the spatial music application is further configured to select the geospatial playlist from the set of geospatial playlists based upon one or more substantially current environmental parameters associated with the current geospatial location of the portable electronic device.

3. The system of claim 2 wherein the one or more substantially current environmental parameters comprise at least one of a lighting condition parameter, seasonal parameter, and weather condition parameter.

4. The system of claim 1 wherein the spatial music application is further configured to select the geospatial playlist from the set of geospatial playlists based upon one or more substantially current motion parameters associated of the portable electronic device.

5. The system of claim 4 wherein the one or more substantially current motion parameters comprise at least one of a direction of motion of the portable electronic device, an orientation of the portable electronic device, a facing direction of a user of the portable electronic device, a speed of motion of the portable electronic device, and a time duration for which the portable electronic device has been within a particular area.

6. The system of claim 1 wherein the spatial music application is further configured to select the geospatial playlist from the set of geospatial playlists based upon a genre parameter associated with the selected geospatial playlist.

7. The system of claim 6 wherein the genre parameter indicates at least one of a type or style of the musical media files represented within the selected geospatial playlist.

8. The system of claim 1 wherein the spatial music application is further configured to select the geospatial playlist from the set of geospatial playlists based upon a user access parameter associated with the selected geospatial playlist.

9. The system of claim 8 wherein the user access parameter limits access to the selected geospatial playlist to users who are documented members of a particular group.

10. The system of claim 1 wherein the automated media file selection process is based at least in part upon a random number.

11. The system of claim 1 wherein the automated media file selection process is based at least in part upon musical taste data of the user.

12. The system of claim 1 wherein the automated media file selection process is based at least in part upon music listening history data of the user.

13. The system of claim 1 wherein the identified particular musical media file is automatically played by the portable electronic device after being identified.

14. The system of claim 1 wherein the identified particular musical media file is conditionally played by the portable electronic device after being identified, the conditional play being dependent upon an acceptance interaction of the user with the portable electronic device.

15. The system of claim 1 wherein the identified particular musical media file is only played by the portable electronic device after a currently playing media file completes play.

16. The system of claim 1 wherein a least a portion of the spatial music application is executed by a spatial media server that is separate from the portable electronic device.

17. The system of claim 16 wherein the portable electronic devices sends geospatial location data to the spatial media server over a communication link and the spatial media server sends musical media data to the portable electronic device over the communication link.

18. A method for selecting and playing musical media to a user based at least in part upon the user's geospatial location, comprising:
determining a current geospatial location of a portable electronic device of the user;
accessing a stored set of geospatial playlists, each geospatial playlist comprising a listing of a plurality of musical media files, and each geospatial playlist being relationally associated with at least one geospatial location or geospatial area;
selecting a geospatial playlist from the set of geospatial playlists based at least in part upon a determined correlation between the current geospatial location of the portable electronic device and the at least one geospatial location or geospatial area associated with the selected geospatial playlist;
identifying for play, using an automated media file selection process, a particular musical media file from the plurality of musical media files listed in the selected geospatial playlist; and
causing the play of the identified musical media file on the portable electronic device.

19. The method of claim 18 wherein the determining the current geospatial location is performed at least in part by Global Positioning System electronics.

20. The method of claim 18 wherein the geospatial playlist is selected from the set of geospatial playlists based also upon one or more substantially current environmental parameters associated with the current geospatial location of the portable electronic device.

21. The method of claim 20 wherein the one or more substantially current environmental parameters comprise at least one of a lighting condition parameter, seasonal parameter, and weather condition parameter.

22. The method of claim 18 wherein the geospatial playlist is selected from the set of geospatial playlists based also upon one or more substantially current motion parameters associated of the portable electronic device.

23. The method of claim 22 wherein the one or more substantially current motion parameters comprise at least one of a direction of motion of the portable electronic device, an orientation of the portable electronic device, a facing direction of a user of the portable electronic device, a speed of motion of the portable electronic device, and a time duration for which the portable electronic device has been within a particular area.

24. The method of claim 18 wherein the geospatial playlist is selected from the set of geospatial playlist a based also upon a genre parameter associated with the selected geospatial playlist.

25. The method of claim 24 wherein the genre parameter indicates at least one of a type or style of musical media represented within the selected geospatial playlist.

26. The method of claim 18 wherein the automated media file selection process is based at least in part upon a random number.

27. The method of claim 18 wherein the automated media file selection process employs a weighted random selection algorithm that is based at least in part upon musical taste data of the user.

28. The method of claim 18 wherein the automated media file selection process employs a selection algorithm that is based at least in part upon music listening history data of the user.

29. The method of claim 18 wherein the identified particular musical media file is automatically played by the portable electronic device after being identified for play.

30. The method of claim 18 wherein the identified particular musical media file is conditionally played by the portable electronic device after being identified for play, the conditional play being dependent upon an acceptance interaction of the user with the portable electronic device.

31. The method of claim 18 wherein the identified particular musical media file is only played by the portable electronic device after a currently playing media file completes play.

32. The method of claim 18 wherein at least the accessing is performed by a spatial media server that is separate from the portable electronic device.

33. The method of claim 32 wherein the portable electronic devices sends geospatial location data to the spatial media server over a communication link and the spatial media server sends musical media data to the portable electronic device over the communication link.

34. A method for selecting and playing musical media on an electronic device, the method comprising:
determining a current geospatial location of the electronic device;
determining a current environmental condition proximal to the electronic device;
accessing an index of a plurality of musical media files, each musical media file being relationally associated with at least one geospatial location and at least one environmental condition;
selecting a particular musical media file from the plurality of musical media files based at least in part upon a correlation between the current geospatial location and the at least one geospatial location associated with the particular musical media file and based at least in part upon a correlation between the current environmental condition and the at least one environmental condition associated with the particular musical media file; and
playing the selected musical media file on the electronic device.

35. The method of claim 34 wherein the current environmental condition is at least one of a lighting condition, a weather condition, and a seasonal condition.

36. The method of claim 34 wherein the selecting is preformed is based at least in part upon a random selection process.

37. The method of claim 34 wherein the selecting is performed at least in part based upon musical taste data of the user.

38. The method of claim 34 wherein the selecting is performed at least in part based upon music listening history data of the user.

39. The method of claim 34 wherein the selected particular musical media file is conditionally played by the portable electronic device after being selected, the conditional play being dependent upon an acceptance interaction of a user with the electronic device.

40. The method of claim 34 wherein the selected particular musical media file is only played by the electronic device after a currently playing media file completes play.

41. The method of claim 34 wherein at least the selecting is performed by a spatial media server that is separate from the electronic device and which communicates with the portable electronic device over a communication link.

42. A method for selecting and playing musical media on an electronic device, the method comprising:
accessing current location data of a user of the electronic device;
accessing musical genre preference data from the user of the electronic device;
accessing an index of a plurality of musical media files, each musical media file being relationally associated with at least one location and at least one musical genre;
selecting a particular musical media file from the plurality of musical media files based at least in part upon a correlation between the current location data and the at least one location associated with the particular musical media file and based at least in part upon a correlation between the musical genre preference data and the at least one musical genre associated with the particular musical media file; and
playing the selected musical media file to the user.

43. The method of claim 42 wherein the selecting is preformed based at least in part upon a weighted random selection process.

44. The method of claim 42 further comprising accessing current environmental condition data for an environment proximal to the electronic device and wherein the selecting is preformed based further upon a correlation between the current environmental condition data and at least one environmental condition parameter relationally associated with the particular musical media file.

45. The method of claim 44 wherein the at least one environmental condition parameter is at least one of a lighting condition, a weather condition, and a seasonal condition.

46. A method for selecting and playing musical media on an electronic device, the method comprising:
accessing current location data of a user of the electronic device;
accessing at least one of age and gender data associated with the user;
selecting a particular musical media file from a plurality of stored musical media files based at least in part upon a correlation between the current location data and at least one location parameter associated with the particular musical media file, and based at least in part upon a correlation between the at least one of age and gender data of the user and the at least one age or gender parameter associated with the particular musical media file; and
playing the selected musical media file to the user.

47. The method of claim 46 further comprising accessing current environmental condition data for an environment proximal to the electronic device and wherein the selecting is preformed based also upon a correlation between the current environmental condition data and at least one environmental condition parameter relationally associated with the particular musical media file.
